(19) United States
(12) Patent Application Publication
(10) Pub. No.: US 2002/0009350 A1
(43) Pub. Date: Jan. 24, 2002

(54) Retaining device for a connection element

(76) Inventor: Jurg Radtke, Ruti/ZH (CH)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 09/736,963

(22) Filed: Dec. 14, 2000

(30) Foreign Application Priority Data
Dec. 14, 1999 (AT) A 2107/99

(51) Int. Cl. F16B 21/18

(52) U.S. Cl. 411/353

(57) ABSTRACT

The invention describes a retaining device (5) for a tubular sleeve (4) on a bolt-design fixing means (2), having a region of smaller external dimensions between the opposing end regions. An internal cross section dimension of the tubular sleeve (4) is larger than an external dimension disposed perpendicular to a longitudinal median axis (17) of the fixing means (2). The retaining element (6) made from an elastically returnable, deformable material, at least in a radial direction. It has a thickness (19), at least in part regions of its circumference, which is greater than the difference between the external dimensions of a threaded region (12) of the fixing means (2) and the internal cross section dimension of the tubular sleeve (4).

The invention relates to a retaining device of the type outlined in the preamble of claim 1.

A connection system is known from DE 197 50 658 C1, consisting of a sleeve with a screw, displaceable in an axial direction, captively retained therein by means of a retaining device. The screw has a head joined to a cylindrical shank extending in an axial direction, the end region of which is provided with a thread at a distance from the head, the external diameter of the thread being larger than a diameter of the shank. An internal thread pitch in the region of the insertion orifice of the sleeve is shaped by mechanical action once the screw is inserted, so that the screw is captively retained in the sleeve, but the need to provide an internal thread represents an additional production process.

Another assembly unit is known from DE 196 53 226 A1, consisting of a sleeve insertable in an assembly component and a screw. The screw is captively retained by an annular ridge projecting from a screw shank and by a fixing ridge projecting into the internal diameter of the sleeve in the direction of a neck of the screw shank. This design requires a complex screw structure, often preventing the use of less expensive standard screws.

Finally, a fixing assembly is known from EP 0 272 642 B1, essentially consisting of a washer with a sleeve-type collar in which is inserted a fixing screw having ridges upstanding in a radial direction on its shank, and an internal diameter of the collar at the end for inserting the screw has a smaller diameter than a major diameter of the ridges, whereby the screw is captively retained. This design also requires a complex process to produce a screw with ridges on the shank.

The objective of the invention is to provide a retaining device for captively receiving a fixing means in a tubular sleeve, which is simple and, hence inexpensive, to manufacture and assemble.

This objective is achieved by the invention as a result of the features outlined in the characterising part of claim 1. The surprising advantage of this arrangement is that a tubular sleeve can be made by simple tooling and a standard bolt-design fixing means can be captively retained in a simple assembly step by sheathing the fixing means with an elastically returnable, deformable retaining element, thereby producing an axial compensation, which simplifies the use of connection systems for which a retaining device of this type is used.

The embodiment defined in claim 2 is also of advantage, because the assembled parts have sufficient play to guarantee the requisite manufacturing tolerances.

The advantage of an embodiment of the type described in claim 3 is that it produces an accurate vertical axial alignment of the sleeve on a component or alternatively of a damping element between a component and the flange enclosing the sleeve disposed.

Another advantageous embodiment is described in claim 4, which securely anchors the sleeve in a component, in particular a plastics component.

Another possible embodiment is that defined in claim 5, whereby a simple tool structure can be used to make the sleeve, thereby keeping costs to a minimum.

Another advantageous embodiment is described in claim 6, which produces a secure retaining fit even if subjected to axial forces.

The advantageous embodiment defined in claim 7 enables the use of standard initial products, materials, etc..

Claim 8 defines another possible embodiment, which obviates the need to prefabricate and individually insert the retaining element.

Another advantageous embodiment is defined in claim 9, wherein an upstanding section of the bolt-design fixing means, in other words proud of the end region of the tubular sleeve, is avoided, thereby making it easier to align a component on a part of the device prior to assembly.

Claim 10 defines another advantageous embodiment, which permits a longitudinal displacement of the fixing means in the retaining element in a predetermined displacement path.

As a result of the advantageous embodiment outlined in claim 11, the fixing means is securely, i.e. captively, retained in the sleeve.

Other possible embodiments are defined in claims 12 and 13, which enable the fixing means to be detachably retained in the retaining element so that the fixing means is prevented from standing proud of the end region or an end face of the sleeve from projecting out through the fixing means.

Finally, claim 14 defines an advantageous embodiment which enables adjustments to be made to meet different requirements.

To provide a clearer understanding, the invention will be described in more detail with reference to the embodiments illustrated in the appended drawings.

Of these:

FIG. 1 illustrates the retaining device proposed by the invention for a tubular sleeve and a fixing means projecting therethrough, seen in section;

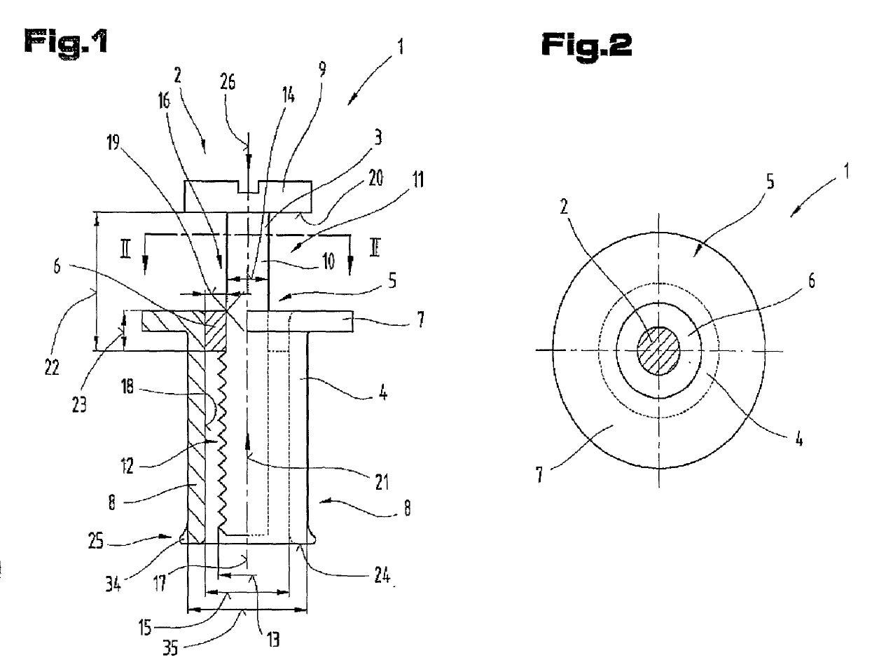

FIG. 2 shows the sleeve with the fixing means and retaining element, in a head-on view, in a section along lines II-II of FIG. 1;

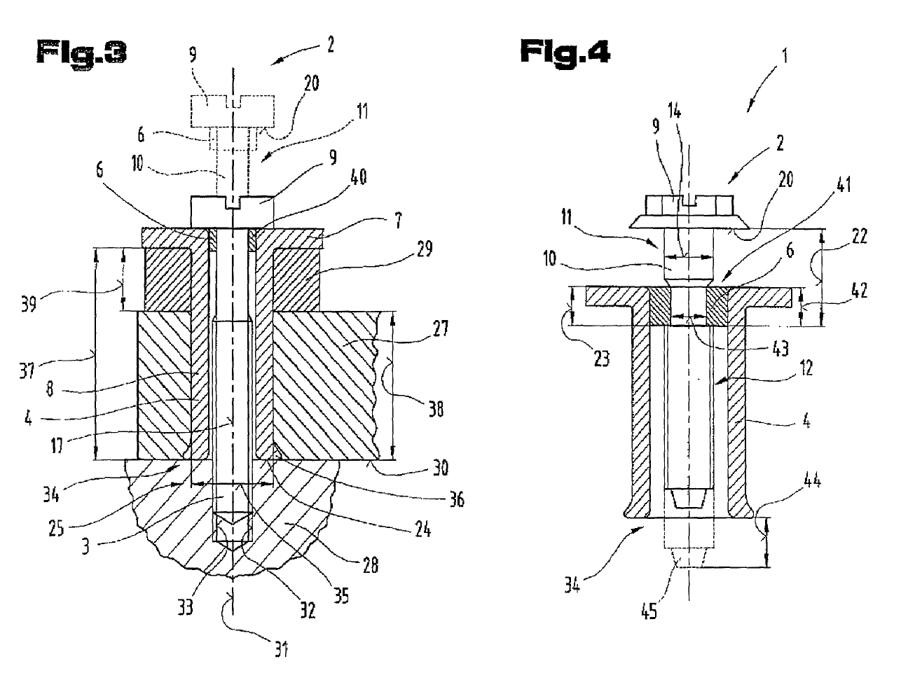

FIG. 3 illustrates how a component is fixed onto a part of the device together with the sleeve in conjunction with the retaining element and an additional damping element, seen in section from a front view;

FIG. 4 illustrates another embodiment of the tubular sleeve captively secured to the fixing means by the retaining element, seen in section from a front view.

Firstly, it should be pointed out that the same parts described in the different embodiments are denoted by the same reference numbers and the same component names and the disclosures made throughout the description can be transposed in terms of meaning to same parts bearing the same reference numbers or same component names. Furthermore, the positions chosen for the purposes of the description, such as top or bottom, relate to the drawing specifically being described and can be transposed in terms of meaning to a new position when another position is being described. Individual features or combinations of features from the different embodiments described may be construed as independent inventive solutions in their own right.

FIGS. 1 to 3 illustrate a connection system 1 consisting of a bolt-design fixing means 2, in particular a screw 3, and a tubular sleeve 4 enclosing the latter. A retaining device 5 consists of a retaining element 6 disposed between the sleeve 4 and the screw 3. The retaining device 5 captively restrains the screw 3 when it is inserted through the retaining element 6 to project into the sleeve 4.

In a preferred embodiment, the sleeve 4 is a deep-drawn component with a flange 7 and the collar 8 extending out from the plane of the flange 7 in an axial direction.

The bolt-design fixing means 2, in particular the screw 3, has a head 9 from which a shank 10 extends in an axial direction, having a cylindrical shank region 11 with no thread adjacent to the head 9 adjoined by a threaded region 12. An external diameter, i.e. an external diameter 13 of the threaded region 12, is bigger than an external dimension, e.g. a diameter 14 in the thread-free shank region 11. A cross-section dimension, e.g. an internal diameter 15, of the collar 8 or sleeve 4 has a larger dimension than a dimension of the diameter 14 of the thread-free shank region 11 as well as the external diameter 13 of the threaded region 12.

The retaining device 5, consisting of the retaining element 6, is placed in the sleeve 4 at an insertion region 16 of the screw 3, the retaining element 6 being made from an annular, elastically returnable, deformable material encasing the shank 10 of the fixing means 2, in which the shank 10 is longitudinally slidably mounted in the direction of the longitudinal median axis 17 and which is supported on the shank 10 and an internal surface 18 of the sleeve 4. Due to the fact that the retaining element is made from an elastically returnable material, being of a thickness 19 such that an external diameter is slightly larger than the internal diameter 15 of the sleeve 4, a radial pre-tension is exerted between the shank 10 and the sleeve 4 and the retaining element 6, once inserted in the sleeve 4, conforms to the diameter 14 of the shank 10, which is smaller than the external diameter 13 of the threaded region 12, causing the retaining device 5 to come into play so that the fixing means 2 is captively retained in the sleeve 4.

The connection system 1 is assembled, in a first step, by pushing the elastically returnable, deformable retaining element 6 over the threaded region 12, enclosing the fixing means 2, as far as the thread-free shank region 11. Then, in a second step, the fixing means 2 encased in the retaining element 6 is inserted in the sleeve 4 and pressed into the sleeve 4 by means of a tension surface 20 applied by the head 9 of the fixing means 2. The fixing means 2 or the screw 3 can then be pulled back out of the sleeve 4 in an axial direction following arrow 21 against the pre-tensioning force exerted by the retaining element 6 across a length 22 of the thread-free region 11 less a height 23 of the retaining element 6, against the retaining force applied by the pre-tensioning force, so that the screw 3 does not project beyond an end face 24 bounding the sleeve 4 in an end region 25 opposite the flange 7. Due to the action of the pre-tensioning force, the screw 3 is retained in this position by a standard manipulation and can only be changed by applying a force in the direction of arrow 26 for the purpose of an assembly process, i.e. a tightening the screw.

FIG. 3 illustrates one possible application of the connection system 1 for securing a component 27 onto a device part 28, for example. There are multiple applications for a connection system 1 of this type in the automotive industry, where, as with the embodiment illustrated here, it is necessary to provide effective damping against vibrations, e.g. from engines.

In order to simplify the procedure of mounting the component 27 on the device part 28 on site, the component 27 is supplied ready-fitted with the connection system 1 and a damping element 29 enclosing the sleeve 4 is provided between the flange 7 and the component 27.

The broken lines indicate the position of the fixing means 2 in which the fixing means 2 is not projecting beyond the end face 24 of the sleeve 4 and hence a surface 30 of the component 27 facing the device part 28. This position is retained by the pre-tensioning force resulting from the pretension exerted by the retaining element 6 between the shank 10 and the internal face 18 of the sleeve 4. Accordingly, the component 27 can be placed and positioned on the device part 28 with the pre-assembled connection system 1—generally speaking a component 27 of this type has a number of such connection systems 1—without the screws 3 projecting beyond the surface 30. If, in spite of the positioning, there is a slight variance between the longitudinal median axis 17 of the screw 3 and the median axis 31 of a bore 33 with an internal thread 32 in the device part 28, this can be compensated by the radial clearance afforded by the difference in diameter between the internal diameter 15 of the sleeve 4 and the external diameter 13 of the thread and can be so by pulling the screw 3 into an axially flush alignment.

By preference, fixing means of this type also have a locating tip at their end region, facilitating insertion in a thread, which is of particular advantage if using automated assembly processes, e.g. with robots.

A variance in the flush alignment between the longitudinal median axis 17 and the median axis 31 due to manufacturing tolerances can also be obtained as a result of the elastic deformability of the retaining element 6.

In order to anchor the sleeve 4 in the component 27—particularly if the latter is made from plastics—the sleeve 4 has a bead-shaped formed zone 34 at the end region 25, for example, where an annular circumferential projection 36 extends beyond an external diameter 35 of the sleeve 4.

In the embodiment illustrated as an example here, a length 37 of the collar 8 is placed against a thickness 38 of the component 27 and an optionally pre-tensioned thickness 39 of the damping element 29 and there is therefore no need to provide an additional packer when securing the component 27 to the device part 28 because the requisite fixing forces, acting in the form of pressure forces in the collar 8, are absorbed thereby. This enables the screw to be duly tightened to predetermined clamping rates, in accordance with the screw specifications, to prevent the connection system 1 from working loose and necessary to secure the connection system 1 sufficiently firmly.

When pre-assembling the connection system 1, the fixing means 2 is fitted with the retaining element 6, e.g. a tube or hose section 40 made from plastics, rubber, etc., which is pushed onto the shank 10 until the head 9 lies against the tension surface 20. The fixing means 2 is then inserted in the sleeve 4 and the head 9 displaced in the direction of the flange 7 so that the tension surface 20 pushes the retaining element 6 into the sleeve 4. This process is facilitated by the rounding in the transition region between the flange 7 and the collar 8. The retaining element 6 is therefore reduced from its originally larger external diameter to the internal diameter 15 of the sleeve 4, thereby producing a press-fit mounting in the sleeve 4. Due to the elasticity of the material of the retaining element 6, this then causes a radial pre-tensioning force on the shank 10 of the fixing means 2 but still allows the threadless shank region 11 to be pushed into an initial position in which the fixing means 2 is not projecting beyond the end face 24 of the sleeve 4. Since the external diameter 13 of the threaded region 12 is larger than the diameter 14 of the shank region 11, the fixing means 2 can only be pulled out by force, destroying the assembly. In this initial position, the connection system 1 is inserted in the component 27, optionally after pushing on a damping element 29 as with the example illustrated in FIG. 3.

Another embodiment of the connection system 1 with the retaining device 5 is illustrated in FIG. 4. In this case, the fixing means 2 is of a special structure and, as shown by way of illustration, the threadless shank region 11 is provided with an annular necking 41 at the transition to the threaded region 12. A width 42 of the necking 41 corresponds approximately to the height 23 of the retaining element 6. A diameter 43 is slightly smaller than the diameter 14 of the adjoining shank 10 running in the direction of the tension surface 20 of the head 9. Accordingly, the retaining element 6 engages so that the fixing means 2 reaches a rest position and an additional initial position in the sleeve 4. The length 22 of the threadless shank region 1 1 corresponds to the sum of the width 42 and a screwing depth 44, as illustrated by broken lines. Furthermore, the fixing means 2 is provided with a locating tip 45 at its thread-side end region, which facilitates insertion in a thread if there is any axial deflection.

Another possible approach and design which may be used for the retaining element 6 is to use injection technology as a means of application, whereby a foaming plastics material is injected or poured into the gap between the threadless shank region 11 and the inner face 18 of the sleeve 4, the shank region 11 being provided with a dividing means prior to applying the material in order to prevent any adhesion on the shank region 11.

For the sake of good order, it should finally be pointed out that in order to provide a clearer understanding of the retaining device proposed by the invention, it and its constituent parts have been illustrated out of scale to a certain extent and/or on an enlarged and/or reduced scale.

The tasks underlying the independent inventive solutions can be found in the description.

Above all, subject matter relating to the individual embodiments illustrated in FIGS. 1, 2, 3; 4 can be construed as independent solutions proposed by the invention. The tasks and solutions can be found in the detailed descriptions relating to these drawings.

### Reference Numbers

1 Connection system

2 Fixing means

3 Screw

4 Sleeve

5 Retaining device

6 Retaining element

7 Flange

8 Collar

9 Head

10 Shank

11 Shank region

12 Threaded region

13 External diameter

14 Diameter

15 Internal diameter

16 Insertion region

17 Longitudinal median axis

18 Face

19 Thickness

20 Tension surface

21 Arrow

22 Length

23 Height

24 End face

25 End region

26 Arrow

27 Component

28 Device part

29 Damping element

30 Surface

31 Median axis

32 Internal thread

33 Bore

34 Formed zone

35 External diameter

36 Projection

37 Length

38 Thickness

39 Thickness

40 Tube-or hose section

41 Necking

42 Width

43 Diameter

44 Screwing depth

45 Locating tip

1. A retaining device for a tubular sleeve on a bolt-design fixing means, having a region of smaller external dimensions between the opposing end regions, the tubular sleeve being provided with retaining elements projecting along a symmetrical longitudinal axis, the sleeve circumferential dimension being smaller than the larger cross section dimensions of the end regions, characterised in that an internal cross section dimension of the tubular sleeve (4) is larger than an external dimension disposed perpendicular to a longitudinal median axis (17) of the fixing means (2) and in that the retaining element (6) is provided in the form of an elastically returnable, deformable material, at least in a radial direction, having a thickness (19), at least in part regions of its circumference, which is greater than the difference between the external dimensions of a threaded region (12) of the fixing means (2) and the internal cross section dimension of the tubular sleeve (4).

2. Retaining device according to claim 1, characterised in that the internal cross section dimension of the tubular sleeve (4) is greater than the region of the fixing means (2) having a reduced external dimension.

3. Retaining device according to claim 1 or 2, characterised in that the tubular sleeve (4) has a circumferential flange (7) in the region of the retaining element (6).

4. Retaining device according to one or more of the preceding claims, characterised in that the tubular sleeve (4) has a bead-shaped formed zone (39) projecting beyond an external diameter (35) on an end region opposite the flange (7).

5. Retaining device according to one or more of the preceding claims, characterised in that the sleeve (4) is conically tapered in the longitudinal direction of the fixing means (2) from the region of the retaining element (6) to the oppositely lying end region.

6. Retaining device according to one or more of the preceding claims, characterised in that the retaining element (6) is retained in the end-face region of the tubular sleeve (4) by means of a press-fit, clamp-fit or by the radially elastic pre-tension.

7. Retaining device according to one or more of the preceding claims, characterised in that the retaining element (6) is provided in the form of a tube or hose section (40), in particular made from plastics, rubber, etc..

8. Retaining device according to one or more of the preceding claims, characterised in that the retaining element (6) is provided as a preferably foaming plastics material once the sleeve (4) has been pushed onto the bolt.

9. Retaining device according to one or more of the preceding claims, characterised in that the bolt-design fixing means (2) has a length in an axial direction from a tension surface (20) of a head (9) of the bolt-design fixing means (2) that is longer than a length (37) of the tubular sleeve (4) and a thread length of the shank (10) which is smaller than the total length of the sleeve (4) by approximately a height (23) of the retaining element (6).

10. Retaining device according to one or more of the preceding claims, characterised in that the shank (10) extending from the tension surface (20) of the head (9) has a first threadless shank region (11) and an adjoining threaded region (12).

11. Retaining device according to one or more of the preceding claims, characterised in that a diameter (14) of the threadless shank region (11) of the fixing means (2) is smaller than an external diameter (13) of the thread.

12. Retaining device according to one or more of the preceding claims, characterised in that the threadless shank region (11) has a necking (41) spaced at a distance from the tension surface (20) of the head (9) with a diameter (43) which is smaller than the diameter (14) of the shank region (11) adjoining the tension surface (20) of the head (9).

13. Retaining device according to one or more of the preceding claims, characterised in that a width (42) of the necking (41) of the shank region (11) corresponds approximately to the height (23) of the retaining element (6).

14. Retaining device according to one or more of the preceding claims, characterised in that a length (22) of the threadless shank region (11) of the fixing means (2) corresponds to the sum of the height (23) of the retaining element (6) and a screwing depth (44) of the fixing means (2) in a threaded bore of a device part (28).
